(19) United States
(12) Patent Application Publication
(10) Pub. No.: US 2014/0007015 A1
(43) Pub. Date: Jan. 2, 2014

(54) ICON DISPLAYING METHOD AND ICON DISPLAY DEVICE

(71) Applicant: MEDIATEK SINGAPORE PTE. LTD., Singapore (SG)

(72) Inventors: Simon EKSTRAND, Eslov (SE); Dan LUO, Shaoshan City (CN)

(73) Assignee: MEDIATEK SINGAPORE PTE. LTD., Singapore (SG)

(21) Appl. No.: 13/836,454

(22) Filed: Mar. 15, 2013

(30) Foreign Application Priority Data
Jun. 29, 2012 (CN) 201210224823.3

(51) Int. Cl. G06F 3/0481

(52) U.S. Cl. CPC G06F 3/04817
USPC 715/836; 715/835

(57) ABSTRACT

An icon displaying method and an icon display device are provided. The icon displaying method includes displaying on a part of a virtual desktop on a displaying field, wherein the virtual desktop is disposed with a plurality of icons; detecting a selection operation from a gesture; scrolling the icons displayed on the displaying field toward a first direction according to the selection operation from the gesture; according to the first direction, determining whether there is an undisplayed icon in a second direction outside of the displaying field on the virtual desktop, wherein the second direction is opposite to the first direction; and when no undisplayed icon is present in the second direction, rotating at least one icon displayed on the displaying field by an angle toward the first direction based on the selection operation from the gesture.

### CROSS REFERENCE TO RELATED APPLICATIONS

This Application claims priority of Chinese Patent No. 201210224823.3, filed on Jun. 29, 2012, and the entirety of which is incorporated by reference herein.

### BACKGROUND OF THE INVENTION

1. Field of the Invention

The present invention relates to a graphical interface and operating system, and in particular to a method and device for icon displaying.

2. Description of the Related Art

As technology advances, the sizes of displaying screens typically employed in mobile communication terminals such as handsets increase. A virtual desktop is often displayed on the displaying screen, which contains a certain number of icons. Users can launch a corresponding software program by clicking on the icon. Since the display screen is limited in size, only a limited number of icons may be shown on the display screen at any time. As more software programs are installed onto the mobile communication terminal, more icons will be shown on the virtual desktop, causing the display screen to be unable to display all icons on the virtual desktop, and consequently the user is required to scroll across the desktop searching for an icon in need.

Conventionally, when searching for an icon, the user is required to perform a selection operation, or scrolling the virtual desktop along a particular direction, as shown in FIG. 1. A mobile terminal 100 includes a displaying screen 101 and an input device 102. The displaying screen 101 displays a part of a virtual desktop 103 on which a plurality of icons 104 is aligned. When the user scrolls the virtual desktop to the right, the virtual desktop shown on the display 101 moves to the left accordingly, displaying undisplayed icons on the left of the virtual desktop 103.

As illustrated in FIG. 2, when the virtual desktop 103 is scrolled to the edge on the left, the left on the display 101 shows the icons at the leftmost side, while preventing the user from carrying on scrolling to the right. However, the user is unable to know that the virtual desktop 103 has reached the edge on the left in a timely manner. As a result, the user will continue scrolling to the right on the virtual desktop. The user will only realize the virtual desktop 103 is not able to scroll further after several scroll attempts.

### BRIEF SUMMARY OF THE INVENTION

A detailed description is given in the following embodiments with reference to the accompanying drawings.

An embodiment of an icon displaying method is described, comprising: displaying on a part of a virtual desktop on a displaying field, wherein the virtual desktop is disposed with a plurality of icons; detecting a selection operation from a gesture; scrolling the icons displayed on the displaying field toward a first direction according to the selection operation from the gesture; according to the first direction, determining whether an undisplayed icon is present in a second direction outside of the displaying field on the virtual desktop, wherein the second direction is opposite to the first direction; and when no undisplayed icon is present in the second direction, rotating at least one icon displayed on the displaying field by an angle toward the first direction based on the selection operation from the gesture.

Another embodiment of an icon display device is provided, coupled to a display displaying a virtual desktop, wherein the virtual desktop comprises a plurality of icons, the icon display device comprising a receiver, a scroller, a determinator and a displaying interface. The receiver is configured to receive a selection signal corresponding to a selection operation from a gesture. The scroller, coupled to the receiver, is configured to generate a scrolling signal for scrolling the icons displayed on the displaying field toward a first direction. The determinator, coupled to the receiver, is configured to determine whether an undisplayed icon is present in a second direction outside of the displaying field on the virtual desktop according to the selection signal to generate a determination signal, wherein the second direction is opposite to the first direction. The displaying interface, coupled to the determinator, is configured to generate a displaying signal based on the determination signal, wherein when no undisplayed icon is present in the second direction, rotating at least one icon displayed on the displaying field by an angle toward the first direction based on the selection operation from the gesture

### BRIEF DESCRIPTION OF THE DRAWINGS

The present invention can be more fully understood by reading the subsequent detailed description and examples with references made to the accompanying drawings, wherein:

FIG. 1 shows a virtual desktop being scrolled according to the related art;

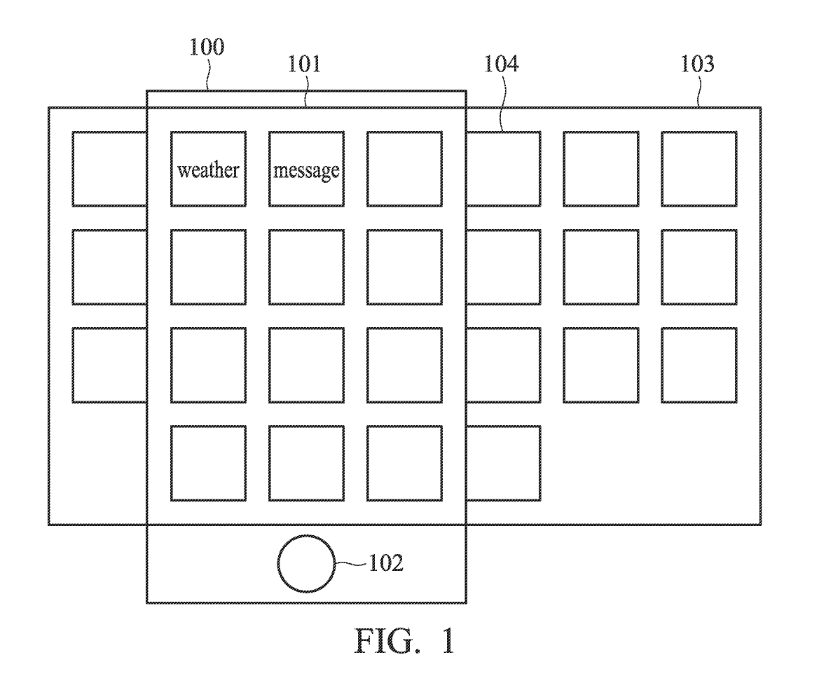

FIG. 2 shows another virtual desktop being scrolled according to the related art;

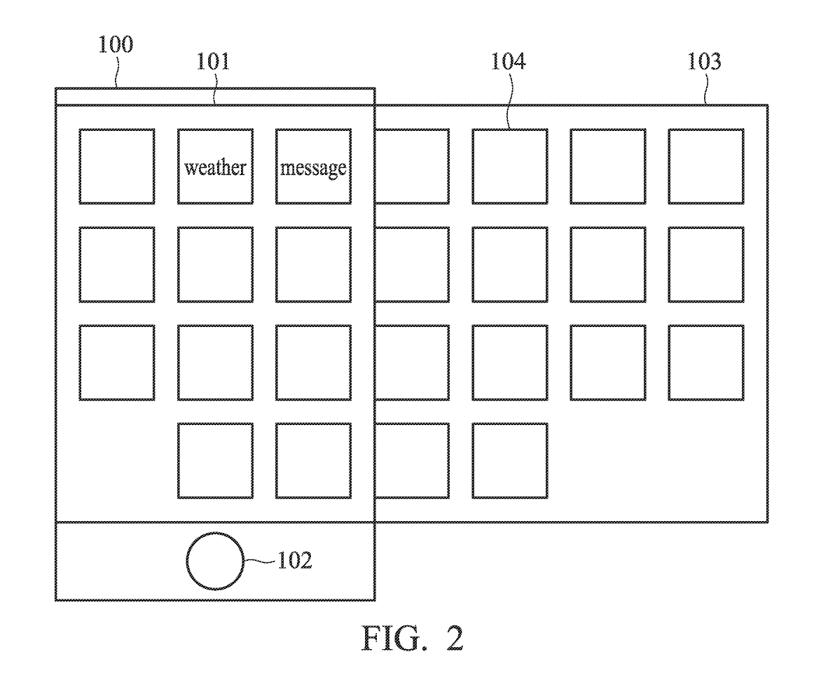

FIG. 3 is a flowchart of an icon displaying method according to an embodiment of the invention;

FIG. 4 shows a virtual desktop according to an embodiment of the invention;

FIG. 5 illustrates the result obtained by scrolling the icons in FIG. 4 to the right;

FIG. 6 illustrates a displaying effect for the rotated icons according to an embodiment of the invention;

FIG. 7 shows a displaying effect for the representation of a wall on the displaying field according to an embodiment of the invention;

FIG. 8 is a flowchart of a method for icon displaying according to another embodiment of the invention;

FIG. 9 displays a 3D desktop according to an embodiment of the invention;

FIG. 10 shows a 3D desktop including the converted 3D icons according to an embodiment of the invention;

FIGS. 11 and 12 are cross-section diagrams for 3D desktops according to an embodiment of the invention;

FIG. 13 is a block diagram of an icon display device 1300 according to an embodiment of the invention;

FIG. 14 is a block diagram of an icon display device 1400 according to another embodiment of the invention; and

FIGS. 15a and 15b illustrate images browsing with a fixed thickness (depth) according to another embodiment of the invention.

FIGS. 16a and 16b illustrate a image browsing containing icons with a fixed thickness or depth.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is electrically connected to another device, that connection may be through a direct electrical connection, or through an indirect electrical connection via other devices and connections.

The embodiments of the invention illustrate a method and device for icon displaying accompanied by various figures for detailed explanation. The icon displaying method and the icon display device in the embodiments can be used in a mobile phone, a personal digital assistant, a mobile terminal, or a fixed terminal. The embodiments employ the mobile terminal, but are not limit thereto, to illustrate the principle of the invention.

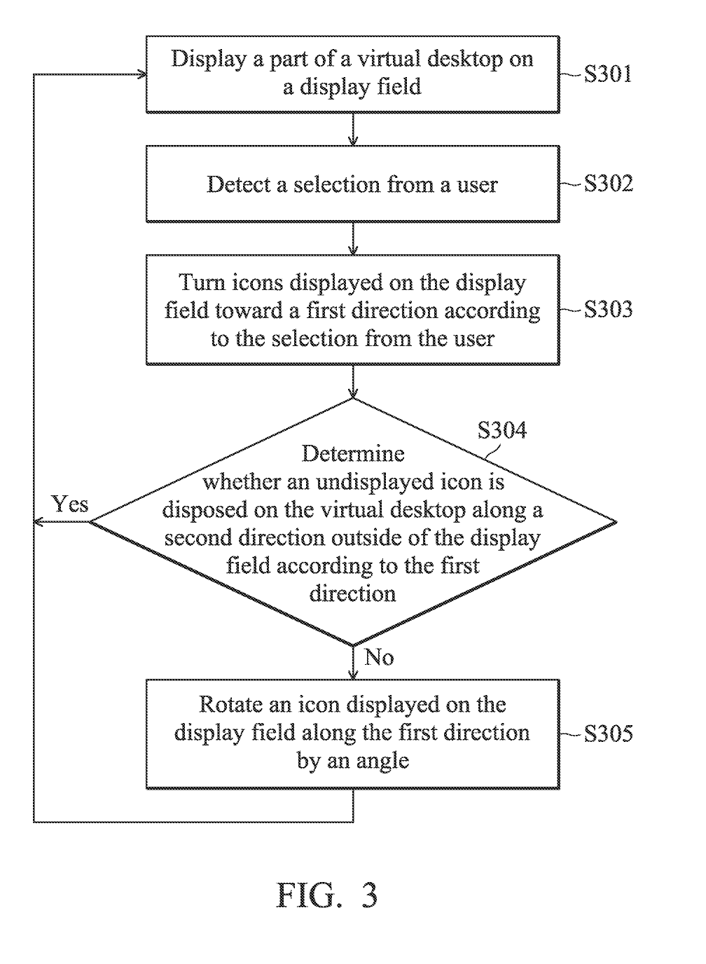

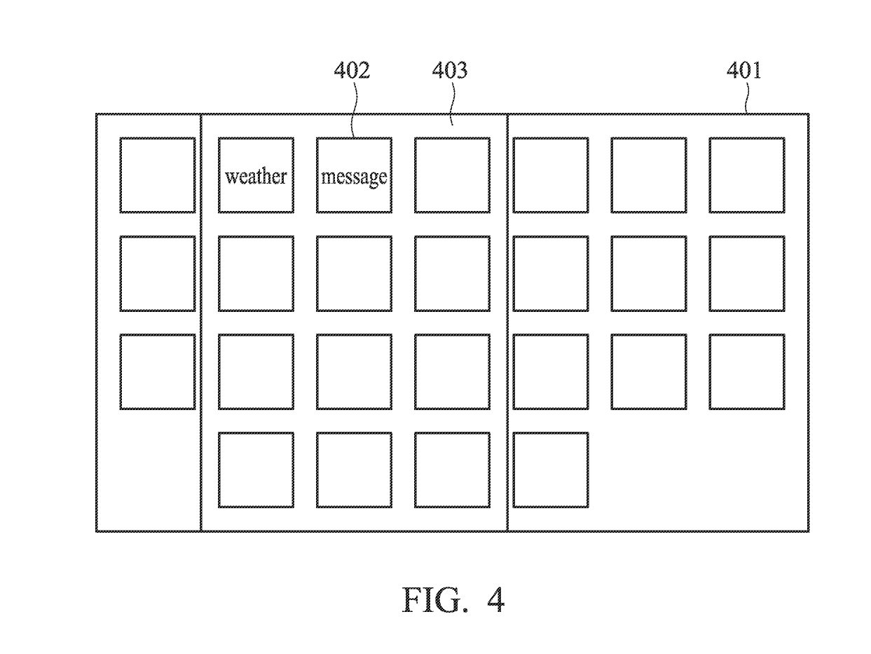

FIG. 3 is a flowchart of an icon displaying method according to an embodiment of the invention. FIG. 4 shows a virtual desktop according to an embodiment of the invention. The following embodiment is explained by incorporating FIGS. 3 and 4. The icon displaying method includes Steps S301 through S305, which are detailed as follows.

First of all, in Step S301, the icon displaying method can display a part of a virtual desktop on a displaying field, with a plurality of icons being disposed on the virtual desktop. The virtual desktop 401 is disposed with at least an icon 402, the displaying field 403 may form a part of the virtual desktop 401, displaying on the screen of a mobile terminal In one embodiment, the displaying field 403 of the virtual desktop 401 is shown on the screen of the mobile terminal, the displaying field 403 may contain icon 402, widgets such as a digital clock, status bar, etc.

Next, in Step S302, the icon displaying method can detect a selection operation from a gesture of a user. In one embodiment, a detection device is disposed on the mobile terminal so that the user can perform a selection operation by the detection device. The detection device may be a touch panel, a trackball, or a button. For example, the user can perform the selection operation by performing a gesture on the touch panel, such as when the user performs a gesture to operate the touch panel, the mobile terminal may regard the selection operation from the user as scrolling the displaying field across the touch panel toward one side. Consequently the mobile terminal can determine that the user's selection operation has been detected from the input device. The user's selection operation may be determined by, for example, a detection device coupled to the touch panel for detecting the direction of the selection operation of the gesture.

In Step S303, the mobile terminal can scroll the icons on the displaying field toward a first direction according to the selection operation from the gesture.

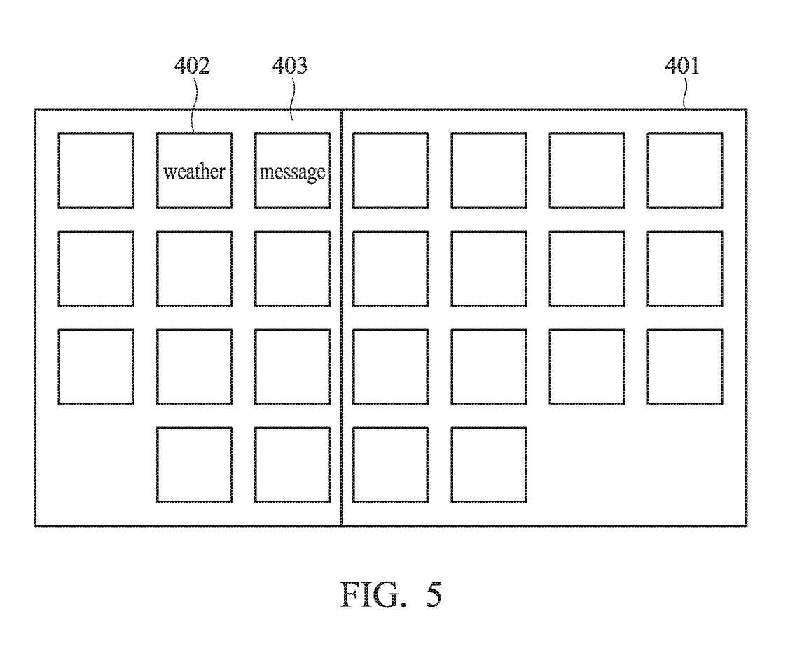

FIG. 5 illustrates an embodiment of FIG. 4. As depicted in FIG. 5, when the user selects the scrolling direction as being toward the right, the first direction is the right direction, and the mobile terminal scrolls the displaying field from icons on the displaying field 403 to the icons on the left of the displaying field 403.

Again in Step S304, the mobile terminal can determine whether there are undisplayed icons on the virtual desktop in the second direction outside the displaying field. The second direction and the first direction are opposite to each other.

In one embodiment, the first direction is to the right, and the second direction is the opposite of the first direction, for example to the left. During Step S303, the mobile terminal can determine whether the virtual desktop shows the undisplayed icons disposed to the left of the displaying field 403. When there are the undisplayed icons disposed to the left of the displaying field 403, the mobile terminal can display the scrolled displaying field with the icons thereon, and carry on to wait for the next selection operation from the gesture. When the undisplayed icons disposed to the left of the displaying field 403 are absent, the icon displaying method then goes to Step S305.

Finally, in Step S305, when no undisplayed icon is found in the second direction, the mobile terminal can rotate at least one icon displayed on the displaying field toward the first direction by an angle.

In the embodiment, as shown in FIG. 5, when no undisplayed icon is found to the left of the displaying field 403, the mobile terminal can determine that the displaying field 403 has reached the edge of the virtual desktop 401. In order to inform the user of that the displaying field has reached the left edge of the virtual desktop 401 in a more intuitive manner, the mobile terminal can rotate the displayed icons on the displaying field 403 to the right by a certain angle, wherein the rotated angle may range from 1 to 90 degrees. Then the mobile terminal can display the rotated result on the displaying field.

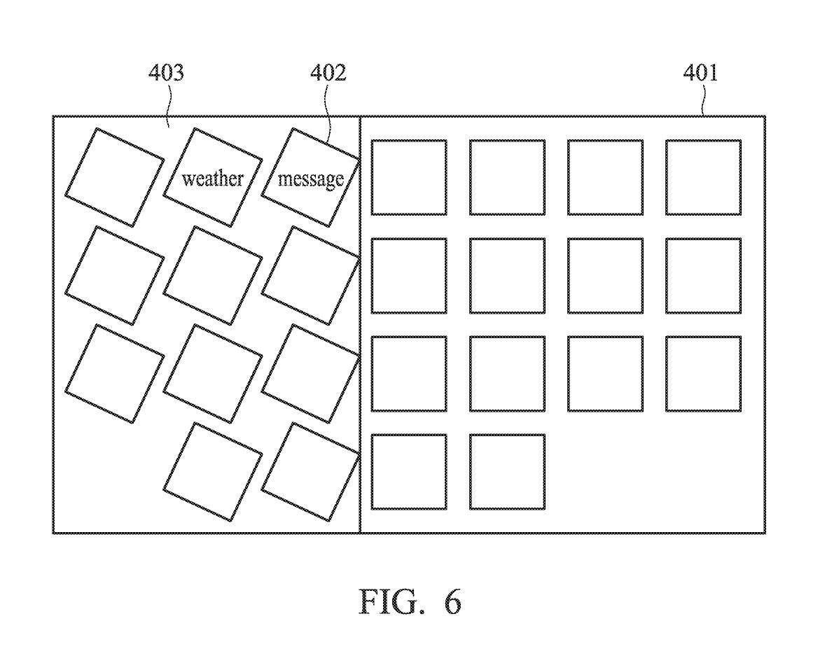

FIG. 6 shows a screen with the rotated icons on the displaying field according to an embodiment of the invention. As illustrated in FIG. 6, when the displaying field 403 scrolls toward the left edge, the mobile terminal can rotate the icons displayed on the displaying field by 20 degrees with respect to a straight line horizontal to the displaying field. Taking a square icon as an example, the icon on the displaying field can be rotated to the right by 20 degrees with reference to the bottom right corner of the displaying field. In another embodiment, after rotating the icons to the right, the icons can be rotated back to the original position. Taking a circular icon as an example, the icon on the displaying field can be rotated to the right by 20 degrees around the original point of the circular icon, or can be rotated to the right by 20 degrees with reference to a horizontal direction around a point to the left of the circular icon.

In one embodiment, all icons on the displaying field 403 are rotated to the right. In other embodiments, the mobile terminal can only rotate one or more columns of the icons at the edge in the second direction, or in other words, the mobile terminal can only rotate the leftmost column or a few of the leftmost columns of the icons.

In one embodiment, the angle of the rotation may be a fixed value, or may be adapted according to the user's selection operation. For example, the angle of the rotation may be configured to be in proportion to the selection operation speed or selection operation movement input by the user. Specifically, when the detection device for detecting the user input is a touch panel, the user can input the selection operation for scrolling over the icons by sliding a finger across the touch panel a distance along the first direction. The faster the finger slides across the touch panel, or the longer the distance that the finger slides on the touch panel, the larger the corresponding angle of rotation is.

The above embodiments provide various icon displaying methods that can serve to alert or remind the user that the scrolling operation has reached the edge of the virtual desktop, preventing the user from performing unnecessary further scrolling actions, thereby enhancing the user's experience.

Although the above embodiments employ the right as the first direction and the left as the second direction, it should be appreciated that the first direction is not limited by the right, but may also be the left, upwards, downwards, or any other direction.

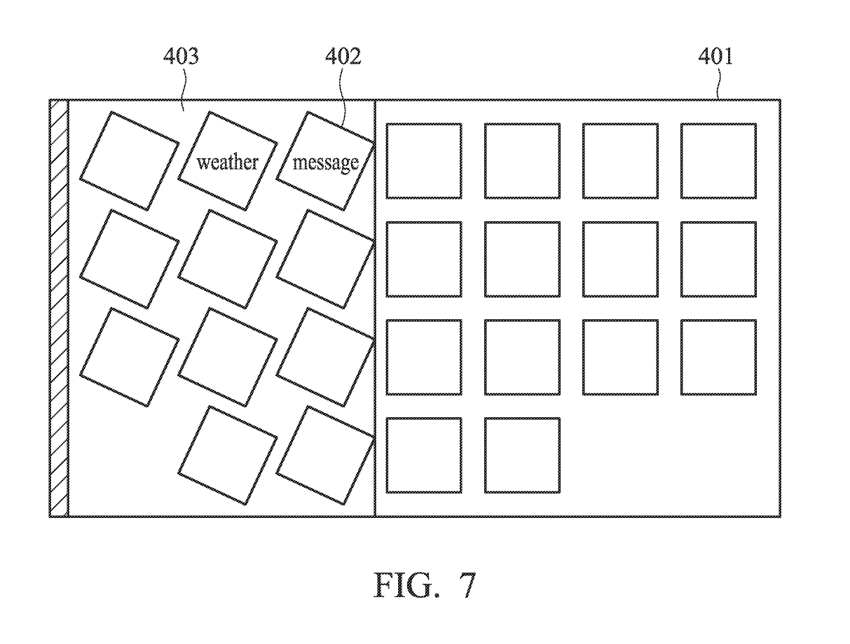

In Step S305, when the undisplayed icons are absent in the second direction, the mobile terminal may display a wall in the second direction of the displaying field. In one embodiment, since the undisplayed icons are absent from the outside of the left edge of the displaying field 403, the mobile terminal shows a wall at the left edge of the displaying field 403 to set it apart from the previous desktop background. FIG. 7 shows the representation of a wall in the displaying field according to an embodiment of the invention. As depicted by FIG. 7, the displaying field 403 is located at the left edge of the virtual desktop 401, and as a result the mobile terminal shows a representation of a wall, which reminds the user that the displaying field 403 has been scrolled to the left edge of the virtual desktop 401.

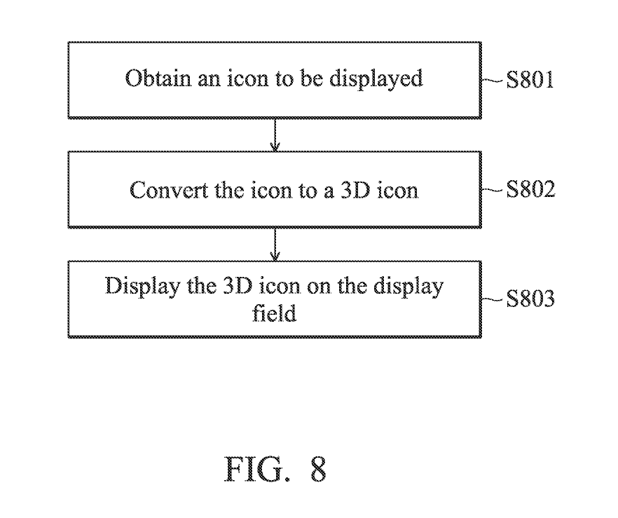

FIG. 8 is a flowchart of another icon displaying method according to an embodiment of the invention. The icon displaying method includes obtaining an icon to be displayed, wherein the icon is a 2-dimentional (2D) icon in Step S801. The icon displaying method further includes converting the icon into a 3D icon in Step S802, and displaying the 3D icon on the displaying field in Step S803.

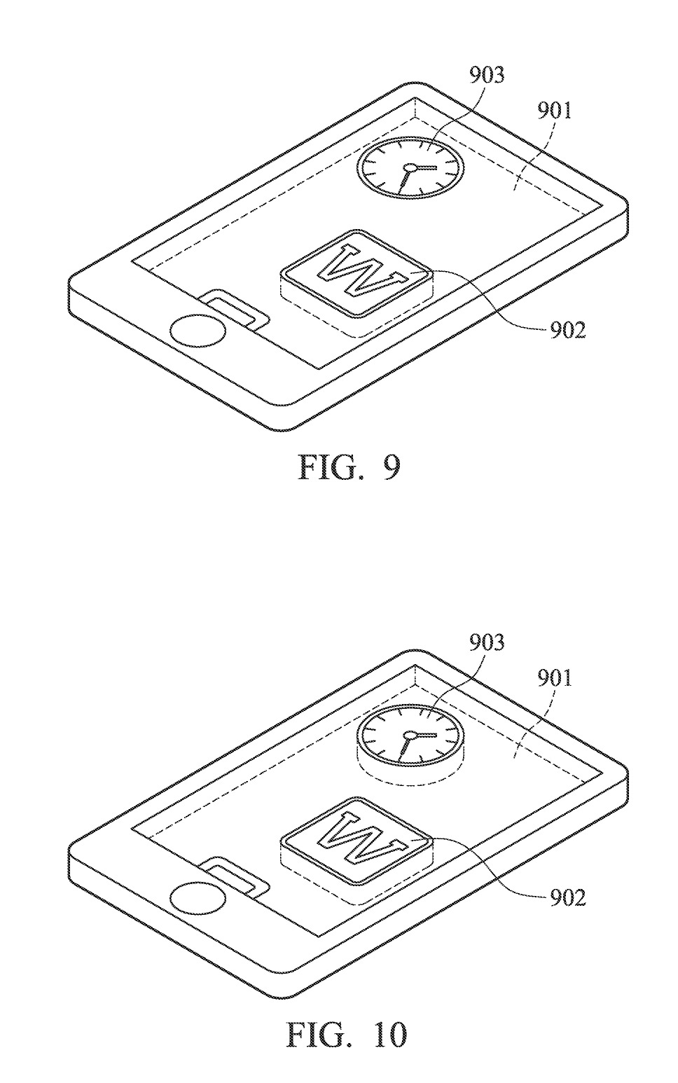

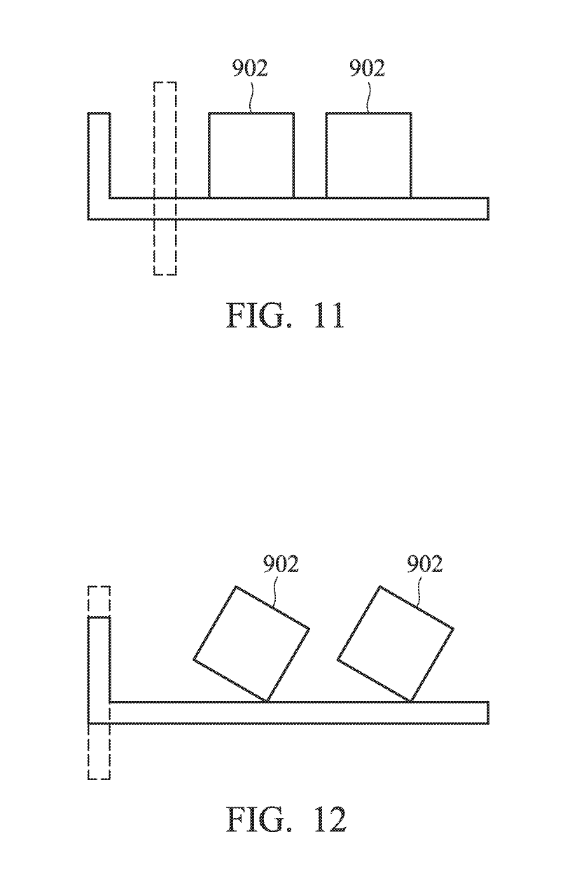

The embodiment in FIG. 8 can incorporate with FIG. 9, which contains a 3D virtual desktop as the virtual desktop including a displaying field 901 as a part of the 3D virtual desktop and 3D icons 902 disposed on the 3D virtual desktop. When the user performs a selection operation to add a new application software, the new application software can generate a 2D icon 903 corresponding to the application software on the desktop. Since only a 3D icon can produce a 3D visual effect on a 3D desktop, the generated 2D icon cannot produce any effect on the 3D desktop. Thus the mobile terminal can convert the 2D icon 903 to the 3D icon according to the image of the 2D icon 903. In one embodiment, the mobile terminal can convert the 2D icon 903 into the 3D icon 904 with a certain thickness or depth. FIG. 10 shows a representation of the 3D desktop with the converted 3D icons. As depicted by FIG. 10, the top images of the 3D icon 904 and 2D icon 903 are the same. The 3D icon 904 is distinct from the 2D icon 903 as the 3D icon 904 has a certain thickness, producing a 3D visual effect for the 3D icon 904. In the embodiment in FIG. 10, the mobile terminal can display the converted 3D icon 904 on the displaying field 901.

The icon displaying method in FIG. 8 can be incorporated into that of FIG. 3. Please refer to FIG. 3 in conjunction with FIG. 8. Steps S801 through S803 are an extension of Step S301. Step S301 can further display at least a part of the virtual desktop on the displaying field with the 3D icons. Moreover, Step S305 can further include rotating the 3D icons by an angle toward the first direction, with reference to a line horizontal to the displaying field.

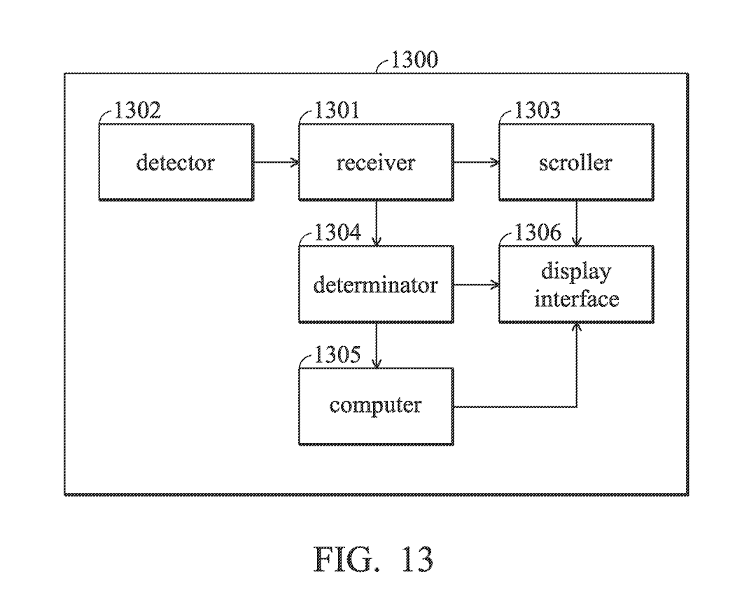

FIGS. 11 and 12 show cross-section diagrams of the 3D virtual desktop according to embodiments of the invention. As shown in FIG. 11, the cross-section for the 3D icon 902 is a rectangular shape. In another embodiment, the cross-section for the 3D icon 902 may be any regular or irregular shape. When the user inputs the selection operation command of sliding to the right, and there is no undisplayed icon on the left, the mobile terminal can rotate the displayed icons on the displaying field by an angle toward the first direction. For example, the mobile terminal can rotate the 3D icon 902 by an angle to the right with reference to a straight line horizontal to the bottom of the displaying field. As depicted in FIG. 12, the mobile terminal can rotate the 3D icon by an angle to the right with reference to a straight line in contact with the right bottom corner and the displaying field. In another embodiment, the mobile terminal can rotate the 3D icon 902 by an angle to the right with reference to a straight line vertical to the bottom of the displaying field.

In yet another embodiment, when the user performs a selection operation by sliding a finger to the right on the touch panel and undisplayed icons are absent from the displaying field, the mobile terminal can rotate the displayed cons on the displaying field toward the first direction by an angle, while displaying a representation of a wall on the left edge of the displaying field, as distinguished from the previous desktop background. As depicted in FIG. 12, when the displaying field has been scrolled to the left edge, the displaying field shows a wall at the left edge, reminding the user that the displaying field has reached the leftmost edge of the 3D virtual desktop.

The above embodiments provide various icon displaying methods that can alert or remind the user that the scrolling operation has reached the edge of the virtual desktop, preventing the user from performing unnecessary scrolling actions, thereby increasing the user experience.

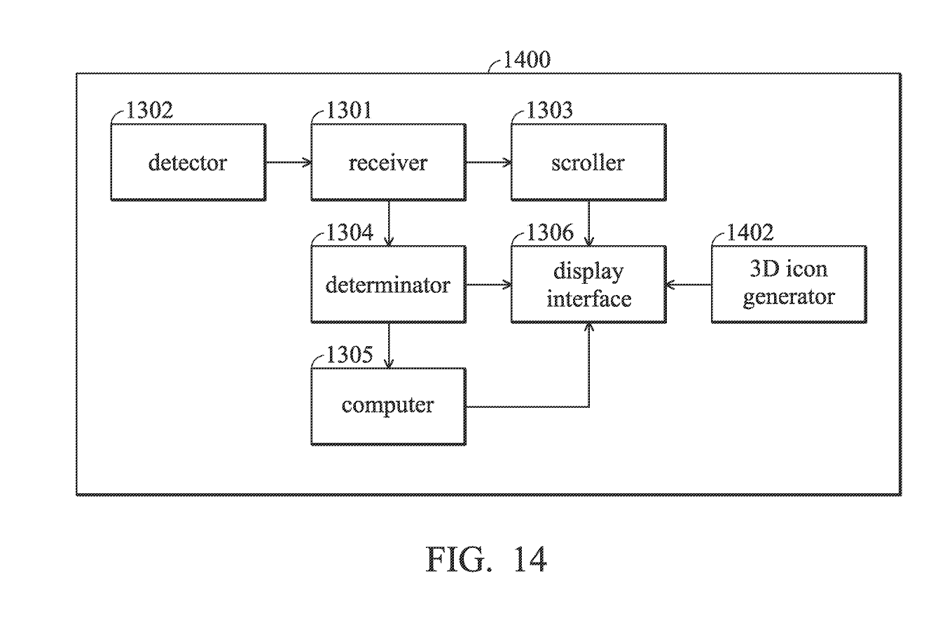

FIG. 13 is a block diagram of an icon display device 1300 according to an embodiment of the invention. The icon display device 1300 is configured to couple a display. The display device 1300 is configured to output a displaying signal to the display for displaying a virtual desktop. The display may be a displaying panel on the mobile terminal As shown in FIG. 13, the icon display device contains a receiver 1301, a scroller 1303, a determinator 1304, and a displaying interface 1306.

The receiver 1303 is configured to receive a selection operation signal. In one embodiment, the receiver 1301 may be coupled to a detector 1302 which may be a touch panel, a scrolling wheel, or a button. The user can perform the selection operation by using the detector 1302. The selection operation made by the user may be by scrolling toward one side of the displaying field on the display. The detector 1302 is configured to detect the selection operation made by the user, and generate a selection operation signal accordingly. The receiver 1301 is configured to operate with the selection operation signal corresponding to the selection operation made by the user. The person having ordinary skill can appreciate that the detector 1301 may be independent from the display device 1300, or incorporated into the display device 1300. The circuit connection and configuration in FIG. 13 only serves as an exemplary implementation. The embodiment in FIG. 13 may be incorporated with that of FIG. 4, i.e., the virtual desktop 401 is disposed with at least an icon 402, the displaying field 403 forms a part of the virtual desktop 401. The display on the mobile terminal can show the displaying field 403 on the virtual desktop 401, and the displaying field 403 can contain the icon 402 which includes widgets such as a digital clock.

The scroller 1303, coupled to the receiver 1301, is configured to generate a scrolling signal based on the selection operation signal, which in rotate is used to scroll the icon on the displaying field toward the first direction. In one embodiment, when the user scrolls the icon toward the right, the displaying field 403 moves to the left on the virtual desktop, displaying the icons on the left of the virtual desktop accordingly. In other words, when the user slides the finger to the right, the detector 1302 can generate the selection operation signal with a direction toward the right. Accordingly, the scroller 1303 can generate the scrolling signal scrolling to the icons on the right based on the selection operation signal with the right direction.

The determinator 1304, coupled to the receiver 1301, is configured to determine whether there is an undisplayed icon on the virtual desktop in the second direction outside of the displaying field according to the selection operation signal, thereby generating a determination signal. The second direction is opposite to the first direction. In one embodiment, the first direction is to the right, and the second direction is opposite to the first direction, or to the left. When the scroller 1303 generates the scrolling signal, the determinator 1304 can concurrently determine whether the virtual desktop 401 has an undisplayed icon disposed on the left outside of the displaying field 403. If the undisplayed icon is disposed on the left outside of the displaying field 403, then the scroller 1303 can continue to generate the scrolling signal for scrolling and displaying the undisplayed icons.

The displaying interface 1306, coupled to the scroller 1303 and the determinator 1304, is configured to generate a displaying signal based on the determination signal. When there is no undisplayed icon in the second direction, the displaying signal is operated according to the selection operation from the user to rotate an icon on the displaying field toward the first direction by an angle, and the scroller 1303 can transmit the generated scrolling signal to the display device, thereby corresponding with displaying the rotated icons on the displaying field rotating toward the first direction by an angle.

In the embodiment as shown in FIG. 5, when the undisplayed icon is absent from the left of the displaying field 403, this indicates that the displaying field 403 has been scrolled to the leftmost edge of the virtual desktop 401. In order to notify the user that the displaying field 403 has reached the leftmost edge of the virtual desktop 401, the displaying interface 1306 can generate a displaying signal which rotates the displayed icons on the displaying field 403 to the right by a certain angle. The angle of the rotation may be a fixed value ranging from 1 to 90 degrees, or may be an adaptive value in proportion to the selection operation of the user. If the angle of the rotation is adaptive according to the selection operation of the user, then the display device can further include a calculator 1305, configured to compute or calculate the angle of the rotation when there is no undisplayed icon in the second direction.

FIG. 6 shows a representation of the display effect for the rotated icons according to an embodiment of the invention. As illustrated in FIG. 6, when the displaying field 403 is scrolled to the left edge, the displaying signal generated by the displaying interface 1306 can rotate the displayed icons on the displaying field to the right by 20 degrees. In the embodiment, a square icon is taken as an example for explanation. The displaying signal generated by the displaying interface 1306 can rotate the displayed icon on the displaying field by 20 degrees, with the right bottom corner of the displayed icon being the center of the rotation. In another embodiment, after rotating the icons to the right, the displaying interface 1306 can restore the icon back to its original position.

In one embodiment, the displaying signal generated by the displaying interface 1306 can rotate all icons on the displaying field 403 to the right. In another embodiment, the displaying signal generated by the displaying interface 1306 can rotate one or several columns of the icons along the edge of the displaying field 403 in the second direction, that is, only rotate one or several columns of the icons at the leftmost side of the displaying field 403.

In the embodiment, the calculator 1305 can compute or calculate the angle of rotation based on the selection operation signal from the user. The angle of rotation is proportional to the speed or displacement of the selection operation action. In practice, when the detector 1302 is a touch panel, the user can slide a finger across the touch panel to input the selection operation action for scrolling the icons, or slide the finger across the touch panel by a distance along the first direction. The faster the finger slides across the touch panel, or the longer the distance that the finger slides on the touch panel, the larger the corresponding angle of icon rotation is.

The above embodiments provide various icon display devices that can alert or remind the user that the scrolling operation has reached the edge of the virtual desktop, preventing the user from performing unnecessary scrolling actions, thereby enhancing user experience.

The above embodiment employs the right as the first direction and the left as the second direction for explanatory purposes, and it should be appreciated that the first direction is not limited by the right, but may also be the left, upwards, downwards, or any other direction.

In one embodiment, when the undisplayed icons are absent in the second direction, the displaying interface 1306 can display a wall at the side of the second direction of the displaying field. In an embodiment, since the undisplayed icons are absent from the outside of the left edge of the displaying field 403, the mobile terminal shows a wall at the left edge of the displaying field 403 to set it apart from the previous desktop background. As depicted by FIG. 7, the displaying field 403 is located at the left edge of the virtual desktop 401, therefore the displaying signal is configured to show a representation of a wall at the left edge, which reminds the user that the displaying field 403 has been scrolled to the left edge of the virtual desktop 401.

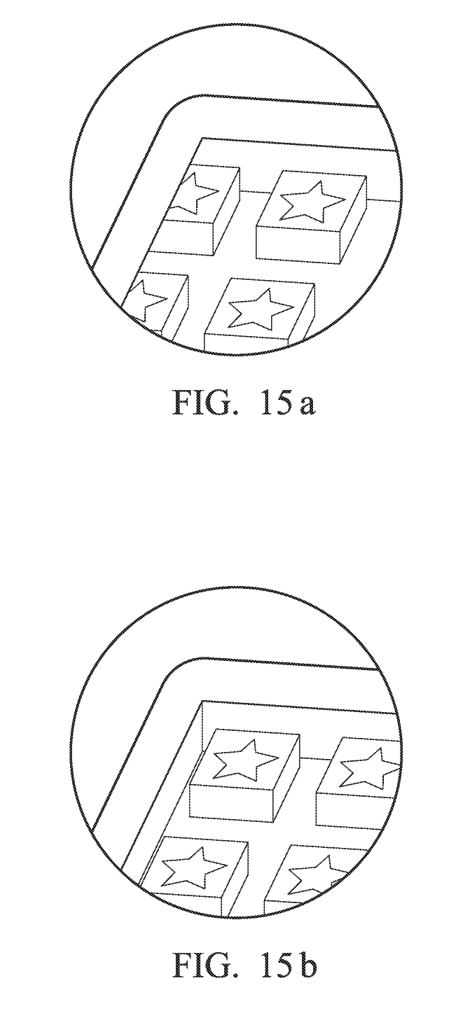

FIG. 14 is a block diagram of an icon display device 1400 according to another embodiment of the invention. In FIG. 14, apart from the devices and components shown in FIG. 13, the icon display device 1440 can further contain a 3D icon generator 1402, configured to convert the icon into a 3D icon.

In the embodiment incorporated with FIG. 9, the virtual desktop is a 3D desktop, the displaying field 901 can display a part of the 3D desktop, and the 3D desktop lines up with the 3D icons 902. When the user installs a new application program, the new application program can generate the 2D icon 903 corresponding to the application program. Then a 3D icon generator 1402 is configured to convert at least one of the icons to be displayed as a 3D icon.

Since only a 3D icon can produce a 3D visual effect on a 3D desktop, the newly generated 2D icon cannot produce any effect on the 3D desktop. Thus the 3D icon generator 1402 can convert the 2D icon into the 3D icon according to the image of the 2D icon 903. In the embodiment, the 3D icon generator 1402 can convert the 2D icon 903 into a 3D icon 904 with a certain thickness or depth. As depicted in FIG. 10, the top images of the 3D icon 904 and 2D icon 903 are the same. The 3D icon 904 is distinct from the 2D icon 903 as the 3D icon 904 has a certain thickness, producing the 3D visual effect for the 3D icon 904. In the embodiment illustrated in FIG. 10, the mobile terminal can display the converted 3D icon 904 on the displaying field 901.

Similar to FIG. 13, when the displaying field 901 displays a 3D desktop with the 3D icons, the displaying signal can rotate the 3D icons toward the first direction by an angle, with respect to a straight line horizontal to the displaying field.

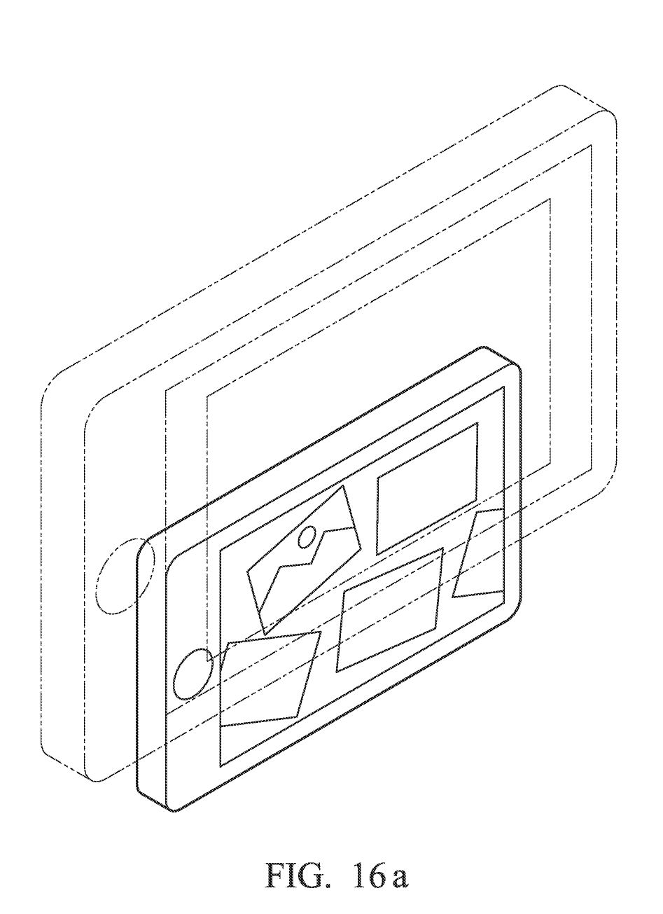

In another embodiment, when the user enters a selection operation instruction consisting of sliding to the right, and undisplayed icons are absent from the left of the displaying field, the displayed icons on the displaying field can be rotated by an angle toward the first direction, and further, a wall may be shown at the left edge of the displaying field to distinguish it from the previous desktop background. As shown in FIG. 12, when the displaying field is scrolled to the left edge of the 3D desktop, the displaying signal displays a wall at the left edge of the displaying field to remind the user that the displaying field has reached the left edge of the 3D desktop. FIGS. 15a and 15b show 3D-icon diagrams according to an embodiment of the invention. In FIG. 15a, the left of the displaying field contains undisplayed icons, therefore other displaying functions may be applicable. For example, all icons may be displayed on the displaying field. FIG. 15b shows that undisplayed icons are absent from the left of the displaying field, wherein the left edge of the desktop shows a wall with the same color as the top edge wall, representing no undisplayed icons being present to the left of the desktop. The realization of the wall at the edge of the desktop is not limited to the disclosure present in the specification, and other display presentations may be adopted in the embodiment by the principle of the invention.

The icon display device reminds the user in an intuitive manner that the scrolling operation has reached the edge of the virtual desktop, preventing the user from performing unnecessary scrolling actions, thereby enhancing user experience.

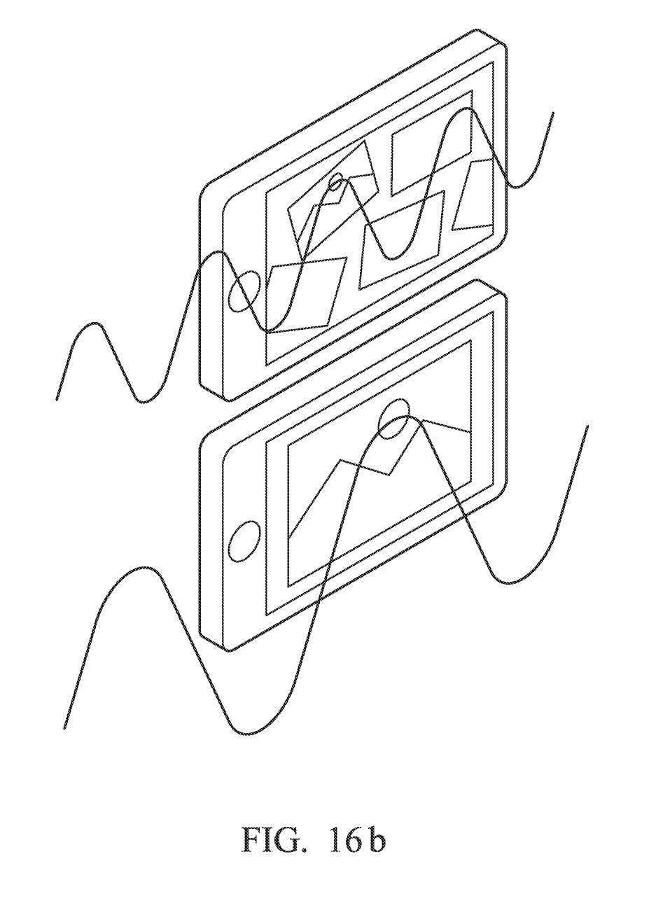

Further, the 3D icon generator in FIG. 14 is not limited to generate a 3D icon during the scrolling desktop icons operation. FIGS. 16a and 16b illustrate a image browsing containing icons with a fixed thickness or depth. For example, the 3D icon generator can convert the image browsing with a fixed thickness into a 3D space with the fixed thickness, as depicted by FIG. 16a. FIG. 16b shows the browsing icons operation, wherein the icons may be arranged and scrolled in a curving manner during the scrolling operation. By displaying the desktop with a fixed thickness or a fixed depth, the 3D icon generator can provide the 3D effect by a simple operation, solving the problem of producing the complex shadow effect for generating a 3D effect with a non-fixed depth.

The various illustrative logical blocks, modules and circuits described in connection with the present disclosure may be implemented or performed with a general purpose processor, a digital signal processor (DSP), an application-specific integrated circuit (ASIC), a field-programmable gate array signal (FPGA), or any other programmable logic device, discrete gate or transistor logic, discrete hardware component, or any combination thereof designed to perform the functions described herein. A general purpose processor may be a microprocessor, but in the alternative, the processor may be any commercially available processor, controller, microcontroller, or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An icon displaying method for an electric device, comprising:
displaying a part of a virtual desktop on a displaying field, wherein the virtual desktop is disposed with a plurality of icons;
detecting a selection operation from a gesture;
scrolling the icons displayed on the displaying field toward a first direction according to the selection operation from the gesture;
according to the first direction, determining whether there is an undisplayed icon in a second direction outside of the displaying field on the virtual desktop, wherein the second direction is opposite to the first direction; and
when there is no undisplayed icon in the second direction, rotating at least one icon displayed on the displaying field by an angle toward the first direction based on the selection operation from the user.

2. The icon displaying method of claim 1, further comprising:
when there is no undisplayed icon in the second direction, displaying a wall at the edge of the displaying field in the second direction.

3. The icon displaying method of claim 1, wherein the angle is proportional to the speed or displacement of the selection operation from the gesture.

4. The icon displaying method of claim 1, further comprising converting the icons displayed on the displaying field into 3D icons.

5. The icon displaying method of claim 4, wherein the step of converting the icons comprises converting the icons displayed on the displaying field into the 3D icons with a first thickness.

6. The icon displaying method of claim 1, wherein the step of rotating at least one icon comprises rotating the icon by the angle toward the first direction, with reference to a straight line parallel to the edge of the displaying field.

7. An icon display device, coupled to a display displaying a virtual desktop, wherein the virtual desktop comprises a plurality of icons, the icon display device comprising:
a receiver, configured to receive a selection signal corresponding to a selection operation from a gesture;
a scroller, coupled to the receiver, configured to generate a scrolling signal for scrolling the icons displayed on the displaying field toward a first direction;
a determinator, coupled to the receiver, configured to determine whether there is an undisplayed icon in a second direction outside of the displaying field on the virtual desktop according to the selection signal to generate a determination signal, wherein the second direction is opposite to the first direction; and
a displaying interface, coupled to the determinator, configured to generate a displaying signal based on the determination signal, wherein when there is no undisplayed icon in the second direction, rotating at least one icon displayed on the displaying field by an angle toward the first direction based on the selection operation from the gesture.

8. The icon display device of claim 7, wherein when there is no undisplayed icon in the second direction, the displaying signal is configured to display a wall at the edge of the displaying field in the second direction.

9. The icon display device of claim 7, further comprising a calculator configured to calculate the angle based on the selection signal when there is no undisplayed icon in the second direction.

10. The icon display device of claim 9, wherein the angle is proportional to the speed or displacement of the selection operation from the gesture.

11. The icon display device of claim 7, further comprising a 3D icon generator, configured to convert the icons displayed on the displaying field into 3D icons.

12. The icon display device of claim 11, wherein the 3D icon generator is configured to convert the icons displayed on the displaying field into the 3D icons with a first thickness.

13. The icon display device of claim 7, wherein the displaying interface is configured to rotate the icon by the angle toward the first direction, with reference to a straight line parallel to the edge of the displaying field.

14. The icon display device of claim 7, further comprising a detector, coupled to the receiver, and configured to detect the selection operation from the gesture and generate the selection signal.

15. The icon display device of claim 14, wherein the detector is a touch panel or a keyboard.

16. A computer usable medium having computer readable program code means for displaying an icon on an electric device, comprising:
first program code means for displaying a part of a virtual desktop on a displaying field, wherein the virtual desktop is disposed with a plurality of icons;
second program code means for detecting a selection operation from a gesture;
third program code means for scrolling the icons displayed on the displaying field toward a first direction according to the selection operation from the gesture;
fourth program code means for determining whether there is an undisplayed icon in a second direction outside of the displaying field on the virtual desktop according to the first direction, wherein the second direction is opposite to the first direction; and
fifth program code means for rotating at least one icon displayed on the displaying field by an angle toward the first direction based on the selection operation when there is no undisplayed icon in the second direction.

17. the computer usable medium of claim 16, wherein:
the first program code means father for displaying a wall at the edge of the displaying field in the second direction, when there is no undisplayed icon in the second direction.

18. the computer usable medium of claim 16, wherein the angle is proportional to the speed or displacement of the selection operation from the gesture.

19. the computer usable medium of claim 16, further comprising sixth program code means for converting the icons displayed on the displaying field into 3D icons.

20. the computer usable medium of claim 19, wherein the sixth program code further comprises converting the icons displayed on the displaying field into the 3D icons with a first thickness.
